(19) United States
(12) Patent Application Publication
(10) Pub. No.: US 2025/0314952 A1
(43) Pub. Date: Oct. 9, 2025

(54) CONTROL METHOD, CONTROL DEVICE, AND CONTROL PROGRAM

(71) Applicant: FUJIFILM Corporation, Tokyo (JP)

(72) Inventors: Masahiko SUGIMOTO, Saitama-shi (JP); Tetsuya FUJIKAWA, Saitama-shi (JP)

(73) Assignee: FUJIFILM Corporation, Tokyo (JP)

(21) Appl. No.: 19/245,392

(22) Filed: Jun. 22, 2025

Related U.S. Application Data
(63) Continuation of application No. PCT/JP2023/042216, filed on Nov. 24, 2023.

(30) Foreign Application Priority Data
Dec. 28, 2022 (JP) 2022-211125

(51) Int. Cl. G03B 17/56; G02B 7/06; G02B 7/09; G02B 23/18; H04M 1/02

(52) U.S. Cl. CPC G03B 17/565; G02B 7/06; G02B 7/09; G02B 23/18; H04M 1/0254; H04M 1/026

(57) ABSTRACT

Provided is a control method of an imaging apparatus that is attachable to an optical device in a first state in which imaging via the optical device is possible and a second state different from the first state. The control method includes switching, by a processor, control of the imaging apparatus based on information indicating whether or not the imaging apparatus is attached to the optical device in the second state.

### CROSS-REFERENCE TO RELATED APPLICATIONS

This is a continuation of International Application No. PCT/JP2023/042216 filed on Nov. 24, 2023, and claims priority from Japanese Patent Application No. 2022-211125 filed on Dec. 28, 2022, the entire content of which is incorporated herein by reference.

### BACKGROUND OF THE INVENTION

### 1. Field of the Invention

The present invention relates to a control method, a control device, and a computer-readable storage medium storing a control program.

### 2. Description of the Related Art

JP2015-200700A discloses an adapter that bonds a portable terminal with a camera function and an optical device having an eyepiece lens, and is used for imaging an image of an object magnified by the optical device with the portable terminal. A portable terminal attachment unit and an optical device attachment unit for attaching the portable terminal and the optical device to a main body such that an optical axis of a camera lens of the portable terminal and an optical axis of an eyepiece lens of the optical device connect in a straight line are provided on the main body back to back. In addition, an opening portion that faces the camera lens on a side of an eyepiece lens of the optical device is formed at a portion of the main body corresponding to the camera lens of the portable terminal.

JP2019-133518A discloses a mobile information terminal and a program for astronomical observation and imaging, which can easily perform astronomical imaging by mounting a camera lens close to an eyepiece inserted into a draw tube of an astronomical telescope, activating an application, selecting an astronomical object to be observed, starting navigation of the astronomical object in a finder mode in which the observation is performed, adjusting an orientation and an inclination of the astronomical telescope with respect to the astronomical object to be observed, and switching to a camera mode in a case where a button of the camera mode for performing imaging is operated.

### SUMMARY OF THE INVENTION

One embodiment according to the technology of the present disclosure provides, for example, a control method, a control device, and a computer-readable storage medium storing a control program that enable appropriate control according to a usage state of an imaging apparatus.

(1)

A control method of an imaging apparatus that is attachable to an optical device in a first state in which imaging via the optical device is possible and a second state different from the first state, in which a processor configured to switch control of the imaging apparatus based on information indicating whether or not the imaging apparatus is attached to the optical device in the second state.

(2)

The control method according to (1), in which the information is a determination result of whether or not the imaging apparatus is attached to the optical device in the second state.

(3)

The control method according to (2), in which the processor is configured to perform determination on whether or not the imaging apparatus is attached to the optical device in the second state, based on a detection result of an object on a first surface side in the imaging apparatus.

(4)

The control method according to (3), in which the first surface is a surface on which an imaging unit that performs imaging via the optical device in the first state is provided in the imaging apparatus.

(5)

The control method according to (3) or (4), in which the processor is configured to perform determination as to whether or not the imaging apparatus is attached to the optical device in the second state based on the detection result of an object on the first surface side in the imaging apparatus and a detection result of an object on a second surface side different from the first surface in the imaging apparatus.

(6)

The control method according to (5), in which the second surface is a surface on which a display device is provided in the imaging apparatus.

(7)

The control method according to any one of (3) to (6), in which the detection result of the object is a detection result related to a distance between the imaging apparatus and the object.

(8)

The control method according to (7), in which the detection result related to the distance is a detection result based on an imaging distance of the imaging apparatus.

(9)

The control method according to any one of (1) to (8), in which the processor is configured to switch power control of the imaging apparatus based on the information.

(10)

The control method according to (9), in which the processor is configured to perform, in a case where the imaging apparatus is attached to the optical device in the second state, control of reducing power consumption of the imaging apparatus as compared with a case where the imaging apparatus is attached to the optical device in the first state.

(11)

The control method according to any one of (1) to (10), in which the processor is configured to perform the control of the imaging with the imaging apparatus based on information indicating whether or not the imaging apparatus is attached to the optical device in the first state.

(12)

The control method according to any one of (1) to (11), in which the processor is configured to switch an interface for an operation related to the imaging in the imaging apparatus based on information indicating whether or not the imaging apparatus is attached to the optical device in the first state.

(13)

The control method according to any one of (1) to (12), in which the imaging apparatus is attachable to the optical device via an adapter.

(14)

The control method according to (13), in which the adapter has a mechanism capable of switching between the first state and the second state.

(15)

The control method according to any one of (1) to (14), in which the processor is configured to: determine whether or not a subject of the imaging is a moving object based on an analysis result of image data obtained by the imaging and a detection result of a displacement amount of the imaging apparatus; and switch between a video mode and a static image mode of the imaging based on a determination result of whether or not the subject of the imaging is the moving object.

(16)

The control method according to any one of (1) to (15), in which the processor is configured to output an adjustment guide of an attachment position of the imaging apparatus to the optical device based on analysis of image data obtained by the imaging.

(17)

The control method according to any one of (1) to (16), in which the optical device is a telescope or a binocle.

(18)

A control device of an imaging apparatus that is attachable to an optical device in a first state in which imaging via the optical device is possible and a second state different from the first state, the control device comprising: a processor, in which the processor is configured to switch control of the imaging apparatus based on information indicating whether or not the imaging apparatus is attached to the optical device in the second state.

(19)

A non-transitory computer-readable storage medium storing a control program of an imaging apparatus that is attachable to an optical device in a first state in which imaging via the optical device is possible and a second state different from the first state, the control program causing a processor to execute processing of: switching control of the imaging apparatus based on information indicating whether or not the imaging apparatus is attached to the optical device in the second state.

### BRIEF DESCRIPTION OF THE DRAWINGS

FIG. 1 is a front perspective view showing an example of an imaging system.

FIG. 2 is a rear perspective view showing an example of the imaging system.

FIG. 3 is a front perspective view showing an example of an adapter.

FIG. 4 is a rear perspective view showing an example of the adapter.

FIG. 5 is a rear perspective view showing an example of a state in which a holding portion is rotated to a first position and a second position in the adapter.

FIG. 6 is a front perspective view showing an example of a first observation mode (first state) of the imaging system.

FIG. 7 is a rear perspective view showing an example of a first observation mode of the imaging system.

FIG. 8 is a front perspective view showing an example of a second observation mode (second state) of the imaging system.

FIG. 9 is a rear perspective view showing an example of a second observation mode of the imaging system.

FIG. 10 is a left side view showing an example of a usage state of the imaging system in a first observation mode.

FIG. 11 is a left side view showing an example of a usage state of the imaging system in a second observation mode.

FIG. 12 is a network configuration diagram of a cloud image management system including a smartphone.

FIG. 13 is a diagram showing an example of a hardware configuration of a smartphone.

FIG. 14 is a flowchart showing a procedure of processing of a control method by a smartphone.

FIG. 15 is a flowchart showing a modification example of the procedure of the processing of the control method by the smartphone.

FIG. 16 is a diagram showing an example of an imaging screen of a smartphone.

FIG. 17 is a diagram showing another example of the imaging screen of the smartphone.

### DESCRIPTION OF THE PREFERRED EMBODIMENTS

In the following, an example of an embodiment of a data generation method, an imaging system, and a data generation program according to the technology of the present disclosure will be described with reference to the accompanying drawings.

First, an imaging system to which the technology of the present disclosure is applied will be described.

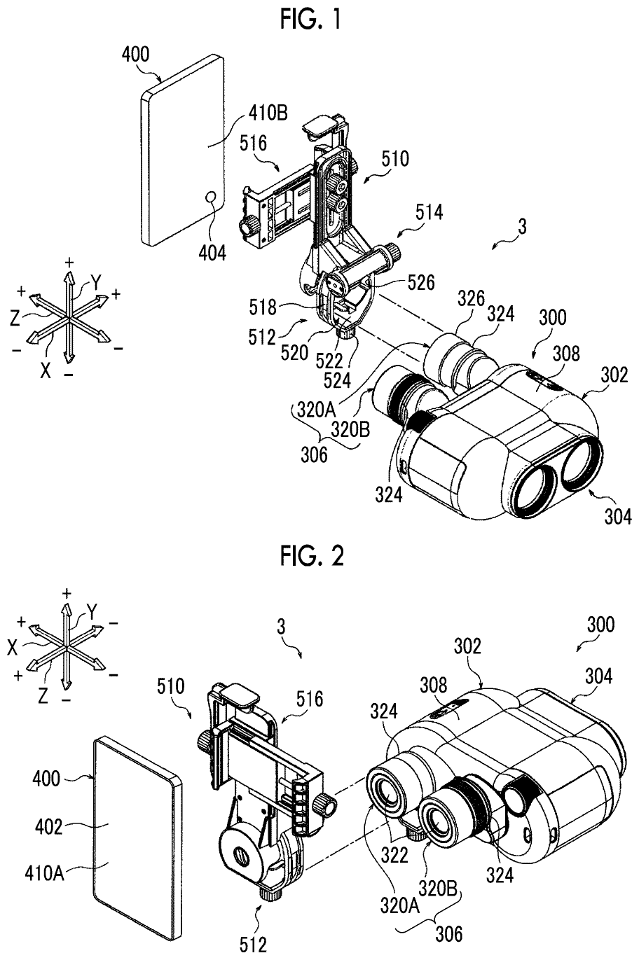

As an example, as shown in FIGS. 1 and 2, the imaging system 3 comprises a binocle 300, a smartphone 400, and an adapter 510. The imaging system 3 corresponds to a set of a binocle 300, a smartphone 400, and an adapter 510. The adapter 510 is a connection device that connects the smartphone 400 to the binocle 300. The imaging system 3 is an example of an “imaging system” according to the technology of the present disclosure. The binocle 300 is an example of an “optical device” according to the technology of the present disclosure. The smartphone 400 is an example of an “imaging apparatus” according to the technology of the present disclosure. The adapter 510 is an example of an “adapter” according to the technology of the present disclosure.

The binocle 300 is, for example, an optical anti-vibration binocle having an anti-vibration function. Here, although an optical anti-vibration binocle is exemplified as an example of the binocle 300, this is merely an example, and the binocle 300 may be any binocle having any function. In the binocle 300, for example, a width direction, a height direction, and a length direction are defined. The width direction, the height direction, and the length direction of the binocle 300 are directions orthogonal to each other. The X direction indicates a width direction of the binocle 300, the Y direction indicates a height direction of the binocle 300, and the Z direction indicates a length direction of the binocle 300.

Hereinafter, a width direction of the binocle 300 will be referred to as an X direction, a height direction of the binocle 300 will be referred to as a Y direction, and a length direction of the binocle 300 will be referred to as a Z direction. In addition, one side of the binocle 300 in the width direction is referred to as an X− side, and the other side of the binocle 300 in the width direction is referred to as an X+ side. In addition, one side of the binocle 300 in the height direction is referred to as a Y+ side, and the other side of the binocle 300 in the height direction is referred to as a Y− side. In addition, one side of the binocle 300 in the length direction is referred to as a Z+ side, and the other side of the binocle 300 in the length direction is referred to as a Z− side.

The binocle 300 comprises a main body 302, an objective optical portion 304, and an ocular optical portion 306. The objective optical portion 304 and the ocular optical portion 306 are arranged in the Z direction via the main body 302. The objective optical portion 304 is provided on the Z− side with respect to the main body 302, and the ocular optical portion 306 is provided on the Z+ side with respect to the main body 302. A Z− side of the binocle 300 corresponds to a distal end side of the binocle 300, and a Z+ side of the binocle 300 corresponds to a rear end side of the binocle 300. The binocle 300 is a binocle having an objective optical portion 304 on a distal end side and an ocular optical portion 306 on a rear end side.

The main body 302 is a portion positioned between the objective optical portion 304 and the ocular optical portion 306 in the binocle 300, and constitutes a main body portion of the binocle 300. The main body 302 has a housing 308. For example, an anti-vibration structure (not shown) that realizes an anti-vibration function is housed inside the housing 308.

The smartphone 400 is formed in a rectangular flat shape in front view. The smartphone 400 comprises a touch panel display 402 and a camera 404. The touch panel display 402 is provided on an entire front surface 410A of the smartphone 400, and the camera 404 is provided at an upper corner portion of a rear surface 410B of the smartphone 400. The rear surface 410B is a surface opposite to the front surface 410A. The camera 404 may be provided flush with the rear surface 410B or may protrude from the rear surface 410B. In addition, the camera 404 may be provided at a position recessed with respect to the rear surface 410B.

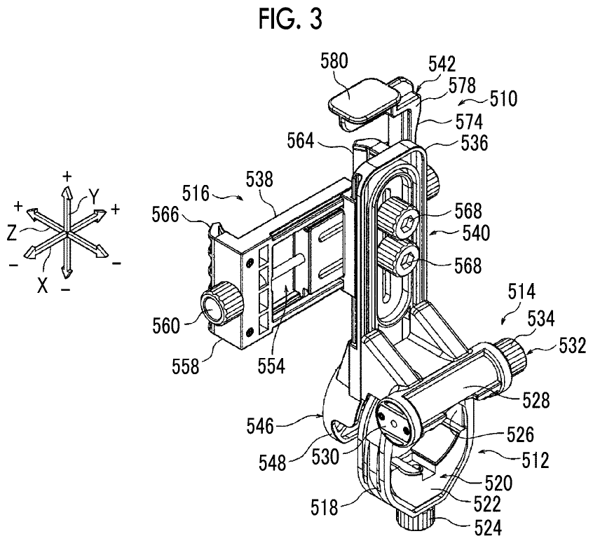

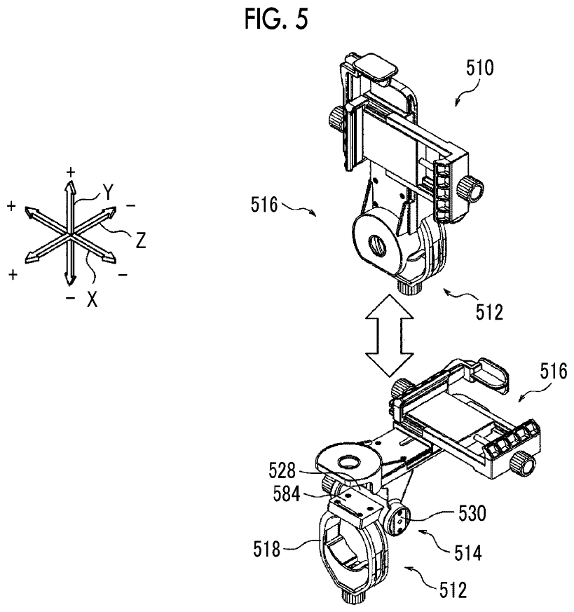

As shown in FIGS. 3 to 5 as an example, the adapter 510 comprises a fixed portion 512, a support portion 514, and a holding portion 516. As shown in FIG. 5, the holding portion 516 is rotatably supported at a first position shown on the upper side of FIG. 5 and a second position shown on the upper side of FIG. 5 by the support portion 514. The first position is a position in a case where the holding portion 516 is rotated to a first end part on the Y+ side in the movable range (that is, a rotation range), and the second position is a position in a case where the holding portion 516 is rotated to a second end part on the Z− side in the movable range. A stopper portion 584 is formed at an end part of the fixing member 518 on the Y+ side. The first end part in the movable range of the holding portion 516 is defined, for example, by the holding portion 516 interfering with the stopper portion 584. In addition, the second end part in the movable range of the holding portion 516 is defined, for example, by providing a stopper structure (for example, a facing surface of the stopper portion 584 on the Z− side) between the rotation support portion 528 and the rotating portion 530.

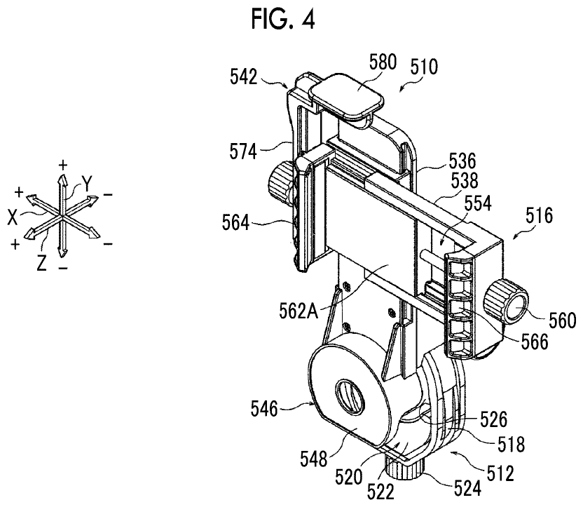

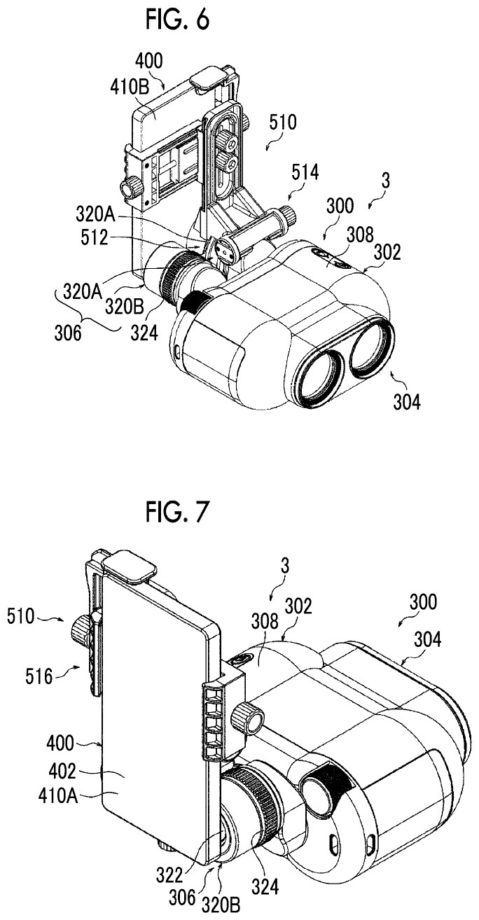

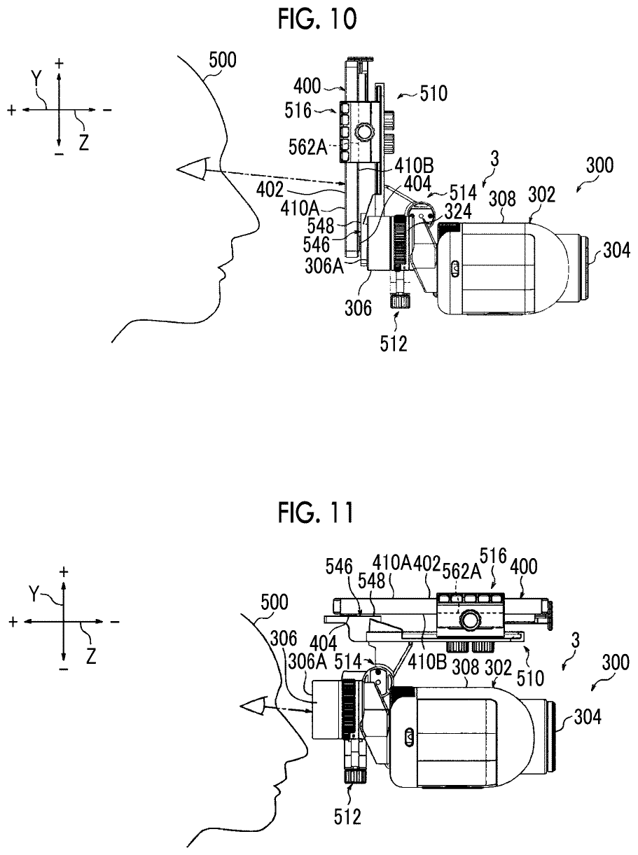

As an example, FIGS. 6 and 7 show a state in which the smartphone 400 is held by the holding portion 516, the adapter 510 is fixed to the binocle 300, and the holding portion 516 is rotated to the first position. Hereinafter, a usage form of the imaging system 3 shown in FIGS. 6 and 7 as an example will be referred to as a first observation mode. In the first observation mode, the holding surface 562A (see FIG. 4) is positioned on the Z+ side with respect to the rear end surface 306A (see FIGS. 10 and 11) of the ocular optical portion 306, and the rear surface 410B of the smartphone 400 faces the rear end surface 306A of the ocular optical portion 306 in the Z direction.

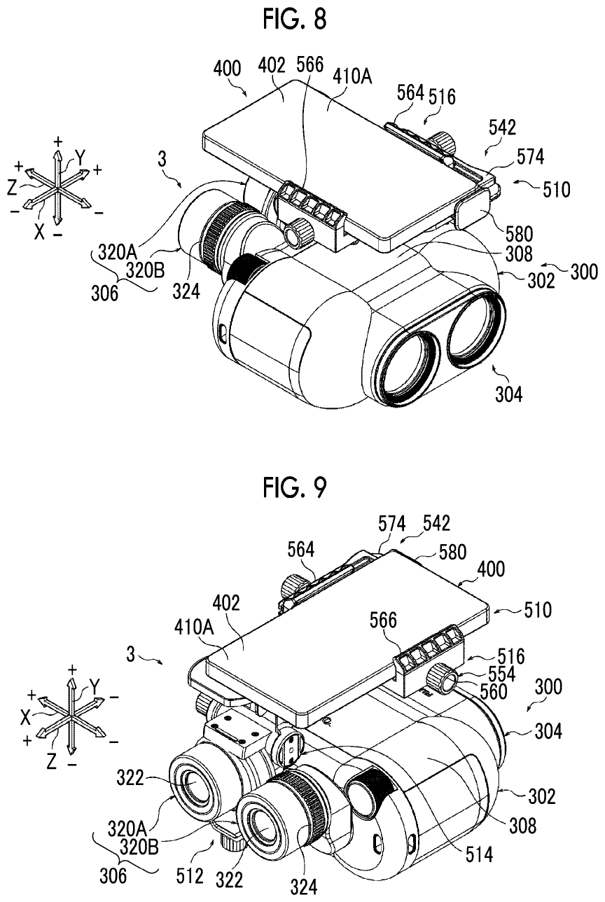

As an example, FIGS. 8 and 9 show a state in which the smartphone 400 is held by the holding portion 516, the adapter 510 is fixed to the binocle 300, and the holding portion 516 is rotated to the second position. Hereinafter, a usage form of the imaging system 3 shown in FIGS. 8 and 9 as an example will be referred to as a second observation mode. In the second observation mode, the entire holding portion 516 including the holding surface 562A (refer to FIG. 4) is positioned on the Z− side (that is, the objective optical portion 304 side) with respect to the rear end surface 306A (refer to FIGS. 10 and 11) of the ocular optical portion 306.

The holding portion 516 is rotated to the second position in a state where the smartphone 400 is held by the holding portion 516, but the holding portion 516 may be rotated to the second position in a state where the smartphone 400 is removed from the holding portion 516, or the smartphone 400 may be removed from the holding portion 516 in a state where the holding portion 516 is rotated to the second position.

Next, an action of the imaging system 3 will be described.

First, a fixing method for fixing the adapter 510 to the binocle 300 will be described. The fixed portion 512 is fixed to the lens barrel 324 of the eyepiece lens portion 320A disposed on the X+ side between the eyepiece lens portion 320A and the eyepiece lens portion 320B provided in the binocle 300. Specifically, the eyepiece lens portion 320A is inserted into a fixing hole 526 (see FIGS. 3 and 4) formed inside the fixing member 518 (see FIGS. 3 to 5), and the position of the fastening member 522 (see FIGS. 3 and 4) is adjusted by the fastening screw 524 (see FIGS. 3 and 4) of the fastening mechanism 520 (see FIGS. 3 and 4), so that the size of the fixing hole 526 is adjusted. Accordingly, the fastening member 522 and the fixing member 518 are fixed to the lens barrel 324 of the eyepiece lens portion 320A in a tightened state.

Next, a holding method of holding the smartphone 400 in the holding portion 516 will be described. First, in a state where a tightened state of a locking screw 560 (see FIGS. 3 and 4) provided in the width adjustment mechanism 554 (see FIGS. 3 and 4) is released, the width between the first holding portion 564 (see FIGS. 3 and 4) and the second holding portion 566 (see FIGS. 3 and 4) is widened. Subsequently, the smartphone 400 is inserted between the first holding portion 564 and the second holding portion 566 in a vertical posture. Subsequently, the widths of the first holding portion 564 and the second holding portion 566 are adjusted to a width at which the smartphone 400 is sandwiched by the first holding portion 564 and the second holding portion 566. Then, the locking screw 560 is brought into a tightened state. Accordingly, the smartphone 400 is held by the first holding portion 564 and the second holding portion 566.

In addition, the position restriction portion 580 (see FIGS. 3 and 4) comes into contact with the smartphone 400 by adjusting the position of the position restricting member 574 (see FIGS. 3 and 4) in a state in which a tightened state of the locking screw 568 (see FIG. 3) provided in the position restriction mechanism 542 (see FIGS. 3 and 4) is released. Then, the locking screw 560 is brought into a tightened state. As a result, the position of the smartphone 400 in the vertical direction is restricted by the position restriction portion 580. The smartphone 400 may be held by the holding portion 516 in a state in which the holding portion 516 is rotated to the first position, or may be held by the holding portion 516 in a state in which the holding portion 516 is rotated to the second position. The position of the smartphone 400 is stored by the position restriction portion 580, and the smartphone 400 can be attached to the same position again after the smartphone 400 is detached.

Next, a method of using the imaging system 3 in a case where the imaging system 3 is in the first observation mode will be described. In the first observation mode, the holding portion 516 is rotated to the first position. In a state where the holding portion 516 is rotated to the first position, a first restriction portion 0548 (see FIGS. 3 and 4) of a light restriction portion 546 (see FIGS. 3 and 4) comes into contact with a rear end surface of the eyepiece lens portion 320A from the Z+ side. In a state in which the holding portion 516 is rotated to the first position, the locking screw 534 (see FIG. 3) provided in the locking mechanism 532 (see FIG. 3) is brought into a tightened state, so that the rotation of the rotating portion 530 (see FIGS. 3 and 5) is restricted with respect to the rotation support portion 528 (see FIGS. 3 and 5). In a state in which the holding portion 516 is rotated to the first position and the smartphone 400 is held by the holding portion 516, the eyepiece lens 322 of the eyepiece lens portion 320A positioned on the X+ side of the pair of eyepiece lens portions (eyepiece lens portions 320A and 320B) faces the camera 404.

Here, in a case where the position of the camera 404 is shifted with respect to the eyepiece lens 322 of the eyepiece lens portion 320A, the position of the smartphone 400 is adjusted by the position adjustment mechanism 540 (see FIG. 3). Specifically, in a state where a tightened state of the locking screw 560 provided in the width adjustment mechanism 554 is released, the second holding member 538 (see FIGS. 3 and 4) slides in at least one direction of the X direction or the Y direction with respect to the first holding member 536 (see FIGS. 3 and 4), and thus the position of the smartphone 400 is adjusted to a position where the camera 404 faces the eyepiece lens 322. Then, the locking screw 560 is brought into a tightened state. As a result, the positions of the smartphone 400 in the X direction and the Y direction are fixed.

In a state in which the camera 404 of the smartphone 400 faces the eyepiece lens 322, light that has passed through the eyepiece lens 322 is incident on the camera 404. Then, the subject is imaged by the camera 404 via the binocle 300, and the image obtained by imaging the subject is displayed on the touch panel display 402. Therefore, as shown in FIG. 10 as an example, the user 500 can check the enlarged image on the touch panel display 402 as compared with a case where the subject is directly imaged with the smartphone 400.

Next, a method of using the imaging system 3 in a case where the imaging system 3 is in the second observation mode will be described. In a case where a tightened state of the locking screw 534 (see FIG. 3) provided in the locking mechanism 532 (see FIG. 3) is released, a state where the rotation of the rotating portion 530 (see FIGS. 3 and 5) is allowed with respect to the rotation support portion 528 (see FIGS. 3 and 5) is obtained. Then, the holding portion 516 is in a state of being rotated from the first position to the second position. The holding portion 516 may be rotated from the first position to the second position in a state in which the smartphone 400 is held by the holding portion 516, or may be rotated from the first position to the second position in a state in which the smartphone 400 is detached from the holding portion 516.

In a state in which the holding portion 516 is rotated to the second position, the locking screw 534 provided in the locking mechanism 532 is brought into a tightened state, so that the rotation of the rotating portion 530 is restricted with respect to the rotation support portion 528. In a state in which the holding portion 516 is rotated to the second position, the entire holding portion 516 including the holding surface 562A is positioned on the Z− side (that is, the objective optical portion 304 side) with respect to the rear end surface 306A of the ocular optical portion 306. Therefore, as shown in FIG. 11 as an example, in the second observation mode, the protrusion of the holding portion 516 to the Z+ side is suppressed as compared with the first observation mode. Therefore, the user 500 can directly look through the ocular optical portion 306.

As shown in FIGS. 1 to 11, the smartphone 400 can be attached to the binocle 300 via the adapter 510. Accordingly, the smartphone 400 can be easily attached to the adapter 510. In the above-described embodiment, the adapter 510 is a member independent of the binocle 300, but the binocle 300 may be a model comprising a mechanism corresponding to the adapter 510.

In addition, as shown in FIGS. 1 to 11, the adapter 510 has a mechanism that is capable of switching between a first state in which the smartphone 400 attached to the binocle 300 can perform imaging via the binocle 300 and a second state different from the first state. The first state corresponds to a “first observation mode” in FIGS. 1 to 11, and the second state corresponds to a “second observation mode” in FIGS. 1 to 11. However, the second state also includes a state in which the smartphone 400 is not attached to the binocle 300, regardless of the adapter 510. Accordingly, it is possible to perform imaging via the binocle 300 and observation through the binocle 300 with the naked eye while the smartphone 400 is attached to the binocle 300. In the embodiments of FIGS. 1 to 11, the optical device is an example of a binocle, but the optical device may be a telescope.

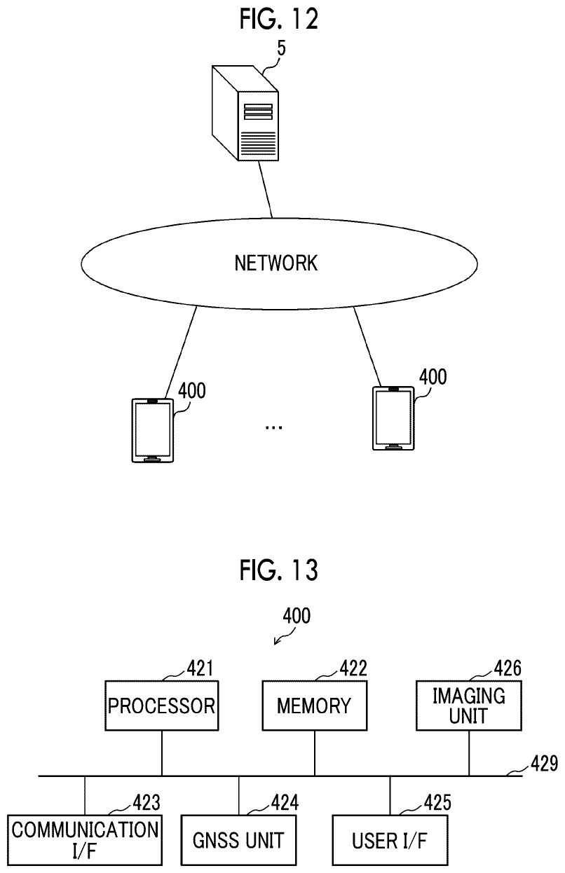

Next, the connection between the smartphone 400 and the external network will be described. As an example, FIG. 12 shows a cloud image management system including a smartphone 400. The smartphone 400 is connected to the image management server 5 via a network such as the Internet. The image management server 5 may be a physical server or a virtual server (so-called cloud server).

As described above, the smartphone 400 can not only directly image the subject by the camera 404 but also image the subject through the binocle 300 (first state). The smartphone 400 transmits image data obtained by imaging to the image management server 5 via a network, and the image management server 5 stores and manages the image data.

Next, a configuration of the smartphone 400 will be described. FIG. 13 is a diagram showing an example of a hardware configuration of the smartphone 400. The smartphone 400 comprises a processor 421, a memory 422, a communication I/F 423, a global navigation satellite system (GNSS) unit 424, a user I/F 425, and an imaging unit 426. The processor 421, the memory 422, the communication I/F 423, the GNSS unit 424, the user I/F 425, and the imaging unit 426 are connected to each other through, for example, a bus 429.

The processor 421 is a circuit that performs signal processing, and is, for example, a CPU that performs control of the entire smartphone 400. The processor 421 may be implemented by another digital circuit, such as an FPGA or a DSP. In addition, the processor 421 may be implemented by combining a plurality of digital circuits with each other.

For example, the memory 422 includes a main memory and an auxiliary memory. The main memory is, for example, a RAM. The main memory is used as a work area of the processor 421. The auxiliary memory is, for example, a non-volatile memory such as a magnetic disk, an optical disk, or a flash memory. The auxiliary memory stores various programs for operating the smartphone 400. The programs stored in the auxiliary memory are loaded into the main memory and executed by the processor 421.

In addition, the auxiliary memory may include a portable memory that can be detached from the smartphone 400. Examples of the portable memory include a memory card such as a universal serial bus (USB) flash drive or a secure digital (SD) memory card, and an external hard disk drive.

The communication I/F 423 is a communication interface that performs wireless communication with the outside of the smartphone 400. For example, the communication I/F 423 indirectly performs communication with the image management server 5 by being connected to the Internet via the moving object communication network. The communication I/F 423 is controlled by the processor 421.

The GNSS unit 424 is, for example, a satellite positioning system such as a global positioning system (GPS), and acquires positional information (longitude and latitude) of the smartphone 400. The GNSS unit 424 is controlled by the processor 421.

The user I/F 425 includes, for example, an input device that receives an operation input from the user, and an output device that outputs information to the user. The input device can be implemented by, for example, a key (for example, a keyboard) or a remote controller. The output device can be implemented by, for example, a display or a speaker. In addition, the input device and the output device may be implemented by a touch panel or the like. The user I/F 425 is controlled by the processor 421.

The imaging unit 426 is a portion having a function of imaging an imaging target, and includes a camera 404. The imaging unit 426 is controlled by the processor 421. The camera 404 is a so-called rear camera installed on a rear surface 410B of the touch panel display 402 on the opposite side. The user 500 can image a subject, such as a landscape, using the rear camera while checking the subject on the touch panel display 402. The imaging unit 426 includes not only the rear camera but also a so-called front camera (not shown). The front camera is installed on a front surface 410A on the same side as the touch panel display 402 and is generally used for imaging the user 500 himself/herself.

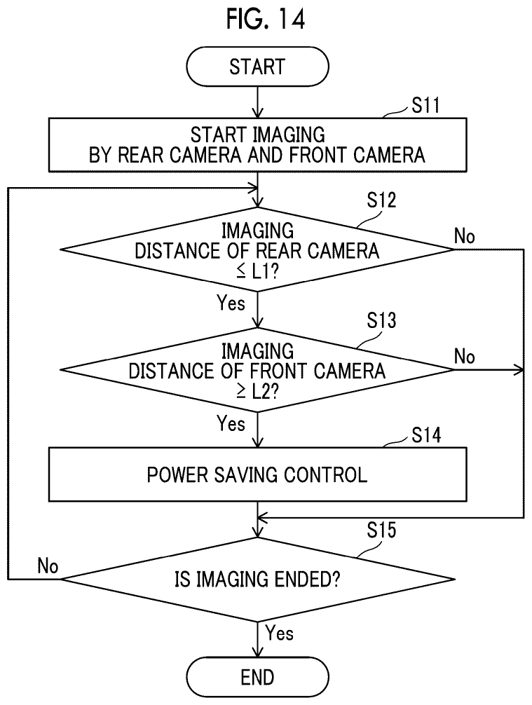

Next, a control method executed by the processor 421 of the smartphone 400 will be described. FIG. 14 is a flowchart showing a procedure of processing of executing a control method of the processor 421 switching control of the smartphone 400 according to an attachment state of the smartphone 400 to the binocle 300. In particular, the processor 421 functions as a control device that switches the control of the smartphone 400 based on information on whether or not the smartphone 400 is attached to the binocle 300 in the second state.

First, the processor 421 activates an application for imaging and starts imaging by the rear camera (camera 404) provided on the rear surface 410B side of the imaging unit 426 and the front camera provided on the front surface 410A (step S11).

Next, the processor 421 determines whether or not the imaging distance of the rear camera is equal to or less than a predetermined distance (for example, the focal length of the rear camera) L1 (step S12).

In a case where the imaging distance of the rear camera is greater than the predetermined distance L1 (imaging distance >L1) (step S12: No), it means that the distance from the smartphone 400 to the object (including the subject) on the rear surface 410B side is large. From this, it is estimated that the imaging system 3 is not in the states as in FIGS. 6 to 11, that is, the smartphone 400 is not attached to the binocle 300 because the binocle 300, which are a type of object, are not close to the rear surface 410B side of the smartphone 400.

In this state, the smartphone 400 is used for imaging with the rear camera regardless of the binocle 300 (a second state in which the smartphone 400 is not attached to the binocle 300). Therefore, the processor 421 determines whether or not the imaging is ended (step S15), ends the processing in a case where the imaging is ended (step S15: Yes), and executes the processing of step S12 again in a case where the imaging is not ended (step S15: No).

On the other hand, in a case where the imaging distance of the rear camera is equal to or less than the predetermined distance L1 (imaging distance ≤L1) (step S12: Yes), it means that the distance from the smartphone 400 to the object (including the subject) on the rear surface 410B side is small. From this, it is estimated that the smartphone 400 is attached to the binocle 300 since the imaging system 3 is in a state as shown in FIGS. 6 to 11, that is, the binocle 300, which is a type of object, is close to the rear surface 410B side of the smartphone 400.

Next, the processor 421 determines whether or not the imaging distance of the front camera is equal to or greater than a predetermined distance (for example, the focal length of the front camera) L2 under the estimation that the smartphone 400 is in a state of being attached to the binocle 300 (step S13).

In a case where the imaging distance of the front camera is shorter than the predetermined distance L2 (imaging distance <L2) (step S13: No), it means that the distance from the smartphone 400 to the object (including the subject) on the front surface 410A side is short. From this, it is estimated that the object, for example, the user 500 is close to the front surface 410A side of the smartphone 400. A typical example of this state is a state in which the user 500 is looking at the touch panel display 402 of the smartphone 400 attached to the binocle 300.

That is, as shown in FIGS. 6, 7, and 10, it is estimated that the smartphone 400 is used for imaging with the rear camera in a state of being attached to the binocle 300 (first state). Therefore, the processor 421 determines whether or not the imaging is ended (step S15), ends the processing in a case where the imaging is ended (step S15: Yes), and executes the processing of step S12 again in a case where the imaging is not ended (step S15: No).

On the other hand, in a case where the imaging distance of the front camera is equal to or greater than the predetermined distance L2 (imaging distance ≥L2) (Step S13: Yes), it means that the distance from the smartphone 400 to the object (including the subject) on the front surface 410A side is large. From this, it is estimated that the object is not close to the front surface 410A side of the smartphone 400.

That is, as shown in FIGS. 8, 9, and 11, it is estimated that the smartphone 400 is not used for imaging with the rear camera in a state of being attached to the binocle 300 (the second state in which the smartphone 400 is attached to the binocle 300). It is estimated that the user 500 does not look at the touch panel display 402 and does not use the touch panel display 402 for imaging with the front camera.

Since the smartphone 400 does not perform imaging and the user 500 does not look at the touch panel display 402, the processor 421 executes a power saving control (step S14). The power saving control is, for example, control of turning off the display of the touch panel display 402, reducing the brightness of the display, and the like, and specific processing is not limited. After the power saving control, the processor 421 determines whether or not the imaging is ended (step S15). In a case where the imaging is ended, the processor 421 ends the processing (step S15: Yes). In a case where the imaging is not ended (step S15: No), the processor 421 executes the processing of step S12 again.

In a state in which the imaging is performed by the rear camera (step S12: No) or a state in which the imaging is performed by the front camera (step S13: No), the processor 421 does not execute the power saving control, and thus, smooth imaging can be performed. However, even in such a state, it is possible to perform normal power saving control as the smartphone 400, such as sleep control under a condition that there is no operation for a certain period of time.

The control method by the processing of FIG. 14 is a method in which the processor 421 acquires information on whether or not the smartphone 400 is attached to the binocle 300 in the second state (steps S12 and S13), and switches the control of the smartphone 400 based on this information (step S14). Accordingly, in a case where the smartphone 400 is attached to the binocle 300 in a state (second state) in which imaging via the binocle 300 is not possible, that is, in a case where it is estimated that the smartphone 400 is not being used, control (step S14) of suppressing power consumption of the smartphone 400 or the like can be performed. Therefore, it is possible to perform appropriate control according to the usage state of the smartphone 400.

The processor 421 may not determine whether or not the smartphone 400 is attached to the binocle 300 in the second state, and another external device or the like may perform the determination based on the above information. However, in the example of FIG. 14, the information is a determination result of whether or not the smartphone 400 is attached to the binocle 300 in the second state. That is, since the processor 421 also determines whether or not the smartphone 400 is attached to the binocle 300 in the second state, the smartphone 400 can be smoothly controlled according to the usage state.

In addition, the processor 421 determines whether or not the smartphone 400 is attached to the binocle 300 in the second state based on the detection result of the object on the first surface of the smartphone 400, in the present example, the rear surface 410B side (step S12). Specifically, in a case where the object (basically, the binocle 300) is present near the rear surface (first surface) 410B side, the processor 421 determines that the smartphone 400 is attached to the binocle 300 in the first state or the second state (step S12: Yes). On the other hand, in a case where there is no object (basically, the binocle 300) near the rear surface (first surface) 410B side, the processor 421 determines that the smartphone 400 is not attached to the binocle 300 (step S12: No).

Accordingly, the processor 421 can appropriately determine the attachment state of the smartphone 400 to the binocle 300 based on the detection result of the object.

As described above, the first surface here is a rear surface 410B in the smartphone 400 on which a camera (rear camera) 404 as an imaging unit that performs imaging via the binocle 300 in the first state is provided. Accordingly, the imaging unit on the first surface side, which is generally mounted on the smartphone 400, can appropriately determine the attachment state of the smartphone 400 to the binocle 300.

In addition, the processor 421 determines whether or not the smartphone 400 is attached to the binocle 300 in the second state based on the detection result of the object on the first surface (rear surface 410B) side in the smartphone 400 and the detection result of the object on the second surface different from the first surface, which is the front surface 410A side in the present example, in the binocle 300 (step S13). Specifically, in a case where the smartphone 400 is attached to the binocle 300 and there an object (a part of the user 500, which is basically a human body) near the front surface (second surface) 410A side, the processor 421 determines that the smartphone 400 is in the first state because the user 500 is looking at the touch panel display 402. On the other hand, in a case where the smartphone 400 is attached to the binocle 300 and there is no object (a part of the user 500, which is basically a human body) near the front surface (second surface) 410A side, the processor 421 determines that the smartphone 400 is in the second state because the user 500 does not look at the touch panel display 402.

Accordingly, the processor 421 can appropriately determine whether the smartphone 400 is in the first state or the second state in a state in which the smartphone 400 is attached to the binocle 300.

As described above, the second surface here is a front surface 410A of the smartphone 400 on which the display device, that is, the touch panel display 402 is provided. Accordingly, in the smartphone 400, it is possible to appropriately determine whether the smartphone 400 is in the first state or the second state by using the display device on the second surface side that is generally mounted.

In steps S12 and S13, the detection result of the object is a detection result related to the distance between the smartphone 400 and the object. That is, in the present example, the processor 421 determines that the smartphone 400 is attached to the binocle 300 in the second state in a case where the distance on the first surface (rear surface 410B) side is equal to or less than L1 (the smartphone 400 is attached to the binocle 300) and the distance on the second surface (front surface 410A) side is equal to or greater than L2 (the user 500 does not look at the touch panel display 402). Accordingly, the processor 421 can appropriately detect the object based on the detection result related to the distance between the smartphone 400 and the object.

In addition, the detection result related to the distance is a detection result based on the imaging distance of the smartphone 400. Accordingly, the processor 421 can appropriately detect the object based on the imaging of the smartphone 400. The imaging distance is, for example, a focal length of a rear camera or a front camera. However, in a case where the smartphone 400 includes a distance-measuring sensor, a proximity sensor, or the like, values of these sensors may be used as the distance.

Further, the processor 421 can switch the power control of the smartphone 400 based on information indicating whether or not the smartphone 400 is attached to the binocle 300 in the second state (step S14). As a result, the processor 421 can appropriately perform power control of the smartphone 400.

In particular, the processor 421 performs control to reduce the power consumption of the smartphone 400 in a case where the smartphone 400 is attached to the binocle 300 in the second state, compared to a case where the smartphone 400 is attached to the binocle 300 in the first state (step S14). As a result, the processor 421 can reduce power consumption of the smartphone 400.

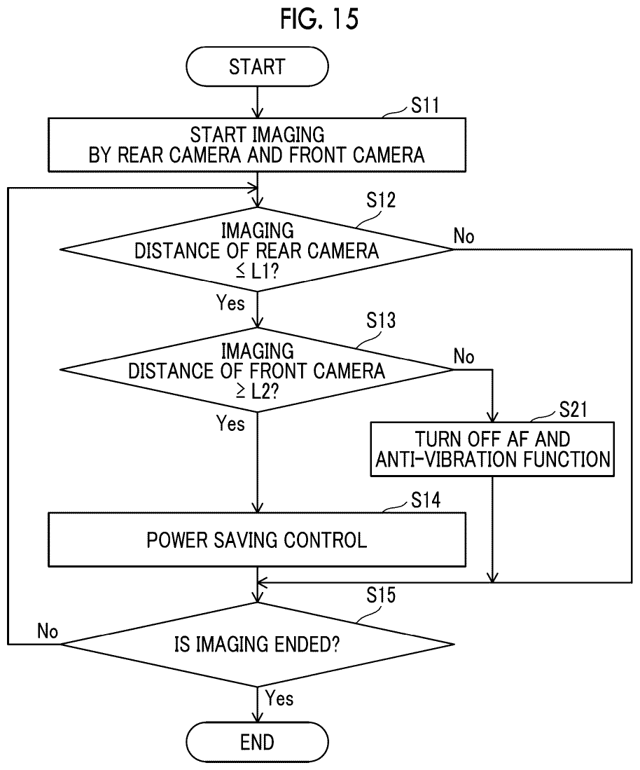

FIG. 15 shows a modification example of the processing of switching the control of the smartphone 400 by the processor 421. This modification example is almost the same as the example of FIG. 14, but in a case where the imaging distance of the front camera is shorter than the predetermined distance L2 (imaging distance <L2) (step S13: No), a step of turning off the autofocus (AF) and the anti-vibration function is added (step S21). That is, in this state, the imaging by the front camera is executed in a state in which the smartphone 400 is attached to the binocle 300, but the processor 421 turns off the AF, the anti-vibration function, and the like in this state.

That is, the processor 421 performs the control of the imaging by the smartphone 400 based on information indicating whether or not the smartphone 400 is attached to the binocle 300 in the first state in which the imaging can be performed via the binocle 300. Examples of the control include AF and the anti-vibration function being turned off. In this case, the focal length is fixed to, for example, the shortest distance. Accordingly, it is possible to suppress a situation in which the functions for imaging, such as the AF and the anti-vibration function, which are designed on the premise of the optical system of the smartphone 400, do not operate normally due to the influence of the binocle 300.

The processor 421 may perform the control, such as turning off the AF and the anti-vibration function, in a case where the imaging distance of the front camera is equal to or greater than the predetermined distance L2 (imaging distance ≥L2) (step S13: Yes) (between step S13 and step S14).

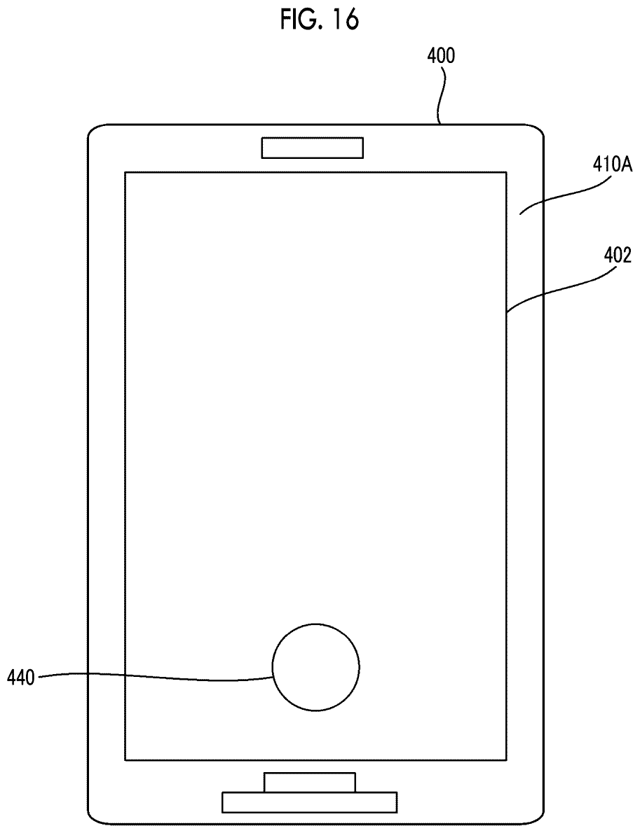

FIG. 16 is an example of an imaging screen of the smartphone 400 and is an example of an interface for the user 500 to operate the smartphone 400. The processor 421 controls the interface by the imaging application. The processor 421 can switch the interface of the operation related to the imaging on the smartphone 400 based on information indicating whether or not the smartphone 400 is attached to the binocle 300 in the first state in which the imaging can be performed via the binocle 300.

FIG. 16 shows an example of an interface in a case of performing imaging in a second state in which the smartphone 400 is not attached to the binocle 300. One imaging button 440 is displayed on the touch panel display 402. The present state is a default state for the smartphone 400.

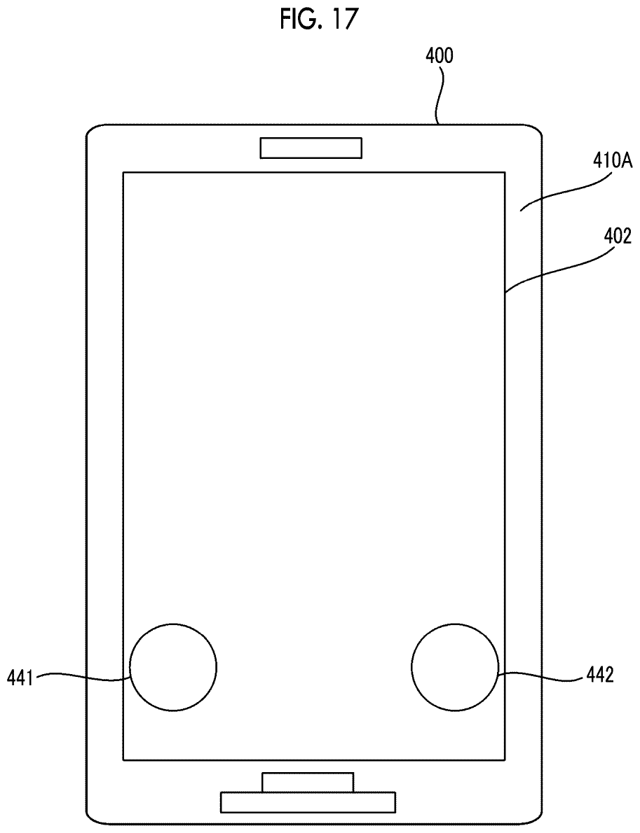

FIG. 17 is another example of the imaging screen of the smartphone 400, and shows an example of an interface in a case where imaging is performed in a first state in which the smartphone 400 is attached to the binocle 300 and imaging through the binocle 300 is possible. In a case where the smartphone 400 is attached to the binocle 300 in the first state, the processor 421 switches the interface from one imaging button 440 in FIG. 16 to two imaging buttons 441 and 442. For example, one of the two imaging buttons 441 and 442 serves as a video capturing start button, and the other serves as a static image capturing button. In addition, imaging may be started by pressing any of the two imaging buttons 441 and 442, and the selection of the video or the static image may be switched by another operation. Further, imaging may be assigned to a physical key (volume button or the like) provided on a side surface or the like of the smartphone 400, instead of operating the button on the touch panel display 402.

In a case where the smartphone 400 is attached to the binocle 300 in the first state, it is desirable that the imaging button can be operated by a finger (thumb) of a hand holding the binocle 300, for example. Therefore, the processor 421 switches the interface for the operation related to the imaging in the smartphone 400 from FIG. 16 to FIG. 17 based on the information on whether or not the smartphone 400 is attached to the binocle 300 in the first state. As shown in FIG. 17, the processor 421 switches the interface such that the operation by the finger (thumb) of the hand of the user 500 is facilitated by displaying the imaging button on the right end or the left end of the touch panel display 402 or assigning the imaging to the physical button (volume button or the like) on the side surface of the smartphone 400. Accordingly, the imaging operation in a state in which the user 500 holds the binocle 300 is facilitated.

The processor 421 may determine whether or not the subject of the imaging is a moving object based on the analysis result of the image data obtained by the imaging and the detection result of the displacement amount of the smartphone 400, and may switch between the video mode and the static image mode of the imaging based on the determination result of whether or not the subject of the imaging is the moving object.

The displacement amount of the smartphone 400 can be acquired by, for example, a gyro sensor incorporated in the smartphone 400. In addition, the determination of whether or not the subject is a moving object can be basically determined by whether or not the subject is moving in the image data. However, in a case where the smartphone 400 is also displaced, it is desirable to subtract the displacement from the determination. Accordingly, the operation of switching between the video mode and the static image mode is automated, and the operation of the smartphone 400 (which is difficult to operate since the binocle 300 needs to be held) attached to the binocle 300 can be easily performed.

In addition, the smartphone 400 may output an adjustment guide for the attachment position of the smartphone 400 to the binocle 300 based on the analysis of the image data obtained by the imaging. For example, in a case where the user 500 performs test imaging in a state where the smartphone 400 is attached to the binocle 300, the touch panel display 402 displays guides such as “Please adjust a little higher”, “It is slightly shifted down”, and “Please rotate the adjustment knob A to the right”. A speaker incorporated in the smartphone 400 may perform the voice output of the guide. Accordingly, it is possible to easily adjust the attachment position of the smartphone 400 for performing imaging via the binocle 300. The generation of the adjustment guide based on the analysis of the image data can be performed by, for example, a learning model that receives the image data as an input and outputs a deviation of the attachment position of the smartphone 400 to the binocle 300 or an appropriate adjustment parameter corresponding to the deviation. Such a learning model can be generated by machine learning based on the image data and the deviation of the attachment position of the smartphone 400 to the binocle 300 or the adjustment parameter.

Each of the embodiments and the modification examples described above can be implemented in combination with each other.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-211125A) filed on Dec. 28, 2022, the content of which is incorporated in the present application by reference.

### EXPLANATION OF REFERENCES

3: imaging system
5: image management server
300: binocle
302: main body
304: objective optical portion
306: ocular optical portion
306A: rear end surface
308: housing
320A, 320B: eyepiece lens portion
322: eyepiece lens
324: lens barrel
400: smartphone
402: touch panel display
404: camera
410A: front surface
410B: rear surface
421: processor
422: memory
423: communication I/F
424: GNSS unit
425: user I/F
426: imaging unit
429: bus
440 to 442: imaging button
500: user
510: adapter
512: fixed portion
514: support portion
516: holding portion
518: fixing member
520: fastening mechanism
522: fastening member
524: fastening screw
526: fixing hole
528: rotation support portion
530: rotating portion
532: locking mechanism
534, 560, 568: locking screw
536: first holding member
538: second holding member
540: position adjustment mechanism
542: position restriction mechanism
546: light restriction portion
548: first restriction portion
554: width adjustment mechanism
562A: holding surface
564: first holding portion
566: second holding portion
574: position restricting member
580: position restriction portion
584: stopper portion

What is claimed is:

1. A control method of an imaging apparatus that is attachable to an optical device in a first state in which imaging via the optical device is possible and a second state different from the first state, the control method comprising;
switching, by a processor, control of the imaging apparatus based on information indicating whether or not the imaging apparatus is attached to the optical device in the second state.

2. The control method according to claim 1,
wherein the information is a determination result of whether or not the imaging apparatus is attached to the optical device in the second state.

3. The control method according to claim 2, the control method comprising:
performing, by the processor, determination on whether or not the imaging apparatus is attached to the optical device in the second state, based on a detection result of an object on a first surface side of the imaging apparatus.

4. The control method according to claim 3,
wherein the first surface is a surface of the imaging apparatus, on which an imaging unit that performs imaging via the optical device in the first state is provided.

5. The control method according to claim 3, the control method comprising:
performing, by the processor, determination on whether or not the imaging apparatus is attached to the optical device in the second state based on the detection result of an object on the first surface side of the imaging apparatus and a detection result of an object on a second surface side different from the first surface of the imaging apparatus.

6. The control method according to claim 5,
wherein the second surface is a surface on which a display device is provided in the imaging apparatus.

7. The control method according to claim 3,
wherein the detection result of the object is a detection result related to a distance between the imaging apparatus and the object.

8. The control method according to claim 7,
wherein the detection result related to the distance is a detection result based on an imaging distance of the imaging apparatus.

9. The control method according to claim 1, the control method comprising:
switching, by the processor, power control of the imaging apparatus based on the information.

10. The control method according to claim 9, the control method comprising:
performing, by the processor, in a case where the imaging apparatus is attached to the optical device in the second state, control of reducing power consumption of the imaging apparatus as compared with a case where the imaging apparatus is attached to the optical device in the first state.

11. The control method according to claim 1, the control method comprising:
performing, by the processor, control of the imaging with the imaging apparatus based on information indicating whether or not the imaging apparatus is attached to the optical device in the first state.

12. The control method according to claim 1, the control method comprising:
switch, by the processor, an interface for an operation related to the imaging in the imaging apparatus based on information indicating whether or not the imaging apparatus is attached to the optical device in the first state.

13. The control method according to claim 1,
wherein the imaging apparatus is attachable to the optical device via an adapter.

14. The control method according to claim 13,
wherein the adapter has a mechanism capable of switching between the first state and the second state.

15. The control method according to claim 1, the control method comprising:
determining, by the processor, whether or not a subject of the imaging is a moving object based on an analysis result of image data obtained by the imaging and a detection result of a displacement amount of the imaging apparatus; and
switching, by the processor, between a video mode and a static image mode of the imaging based on a determination result of whether or not the subject of the imaging is the moving object.

16. The control method according to claim 1, the control method comprising:
outputting, by the processor, an adjustment guide of an attachment position of the imaging apparatus to the optical device based on analysis of image data obtained by the imaging.

17. The control method according to claim 1,
wherein the optical device is a telescope or a binocle.

18. A control device of an imaging apparatus that is attachable to an optical device in a first state in which imaging via the optical device is possible and a second state different from the first state, the control device comprising:
a processor,
wherein the processor is configured to switch control of the imaging apparatus based on information indicating whether or not the imaging apparatus is attached to the optical device in the second state.

19. A non-transitory computer-readable storage medium storing a control program of an imaging apparatus that is attachable to an optical device in a first state in which imaging via the optical device is possible and a second state different from the first state, the control program causing a processor to execute processing of:
switching control of the imaging apparatus based on information indicating whether or not the imaging apparatus is attached to the optical device in the second state.
